(19) United States
(12) Patent Application Publication
(10) Pub. No.: US 2024/0094392 A1
(43) Pub. Date: Mar. 21, 2024

(54) OPTICAL SENSING SYSTEM, OPTICAL SENSING DEVICE, AND OPTICAL SENSING METHOD

(71) Applicant: NEC Corporation, Tokyo (JP)

(72) Inventor: Takahiro Ono, Tokyo (JP)

(73) Assignee: NEC Corporation, Tokyo (JP)

(21) Appl. No.: 18/206,909

(22) Filed: Jun. 7, 2023

(30) Foreign Application Priority Data
Sep. 16, 2022 (JP) 2022-147844

(51) Int. Cl. G01S 17/89; G01S 7/481

(52) U.S. Cl. CPC G01S 17/89; G01S 7/4814; G01S 7/4817

(57) ABSTRACT

The optical sensing system includes a three-dimensional scanner and an intensity determination means. The three-dimensional scanner scans a measurement target with a laser light and receives reflected light of the laser light to generate distance data indicating a distance to the measurement target and luminance data indicating luminance of the reflected light. The intensity determination means dynamically determines intensity of the laser light based on the distance data so as to suppress a change in luminance of the reflected light caused by a length of the distance during the scanning of the three-dimensional scanner.

### INCORPORATION BY REFERENCE

This application is based upon and claims the benefit of priority from Japanese patent application No. 2022-147844, filed on Sep. 16, 2022, the disclosure of which is incorporated herein in its entirety by reference.

### TECHNICAL FIELD

The present disclosure relates to an optical sensing system, an optical sensing device, and an optical sensing method.

### BACKGROUND ART

International Patent Publication No. WO 2021/020570 discloses a Lidar (Light Detection and Ranging) scanner that scans a measurement target with a laser light, measures a distance to the measurement target based on reflected light of the laser light, and generates point cloud data based on a measurement result. The point cloud data is typically a set of point data including XYZ coordinate values.

### SUMMARY

There is a technique of detecting a defect of a measurement target based on point cloud data that is a set of point data including XYZ coordinate values and luminance values obtained by a LiDAR scanner. For example, when a crack occurs on a wall surface of a building, luminance of reflected light from the crack is lower than luminance of reflected light from a region adjacent to the crack. Therefore, using this characteristic, it is possible to detect a defect of the measurement target, such as a crack on a wall surface of a building.

In general, the luminance of reflected light from a measurement point far from the Lidar scanner is relatively lower than the luminance of reflected light from a measurement point close to the Lidar scanner. Therefore, for example, when the measurement target has a recess, the luminance of the reflected light at the recess is lower than the luminance of the reflected light around the recess. Therefore, a luminance difference of the reflected light is generated between the concave portion and the periphery of the concave portion, and there is a possibility that a defect is erroneously detected in the measurement target.

Therefore, an object of the present disclosure is to provide a technique for suppressing a change in luminance of reflected light due to a length (in other words, the shape of the measurement target) of a distance during scanning.

An example object of the invention is to provide an optical sensing system, an optical sensing device, and an optical sensing method.

In a first example aspect, the optical sensing system includes a three-dimensional scanner configured to scan a measurement target with a laser light and receive reflected light of the laser light to generate distance data indicating a distance to the measurement target and luminance data indicating luminance of the reflected light.

The optical sensing system includes an intensity determination unit for dynamically determining intensity of the laser light based on the distance data so as to suppress a change in luminance of the reflected light caused by a length of the distance during the scanning of the three-dimensional scanner.

In a second example aspect, the optical sensing device includes a three-dimensional scanner configured to scan a measurement target with a laser light and receive reflected light of the laser light to generate distance data indicating a distance to the measurement target and luminance data indicating luminance of the reflected light.

The optical sensing device includes an intensity determination unit for dynamically determining intensity of the laser light based on the distance data so as to suppress a change in luminance of the reflected light caused by a length of the distance during the scanning of the three-dimensional scanner.

In a third example aspect, the optical sensing method includes a distance measurement step of scanning a measurement target with a laser light and receiving reflected light of the laser light to generate distance data indicating a distance to the measurement target and luminance data indicating luminance of the reflected light.

The optical sensing method includes an intensity determination step of dynamically determining intensity of the laser light based on the distance data so as to suppress a change in luminance of the reflected light caused by a length of the distance during the scanning.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a functional block diagram of an optical sensing system (Outline of present disclosure);

FIG. 2 is a functional block diagram of an optical sensing system (First example embodiment);

FIG. 3 is an operation flow of a three-dimensional Lidar scanner (First example embodiment); and

FIG. 4 is a functional block diagram of the optical sensing system (Second example embodiment).

### EXAMPLE EMBODIMENT

(Outline of Present Disclosure)

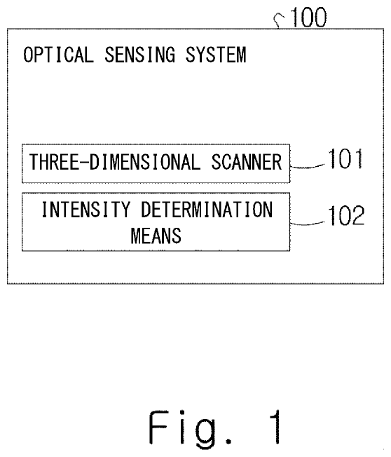

Hereinafter, an outline of the present disclosure will be described with reference to FIG. 1. FIG. 1 illustrates a functional block diagram of an optical sensing system.

As illustrated in FIG. 1, an optical sensing system 100 includes a three-dimensional scanner 101 and an intensity determination means 102.

The three-dimensional scanner 101 scans a measurement target with a laser light and receives reflected light of the laser light to generate distance data indicating a distance to the measurement target and luminance data indicating luminance of the reflected light.

The intensity determination means 102 dynamically determines the intensity of the laser light based on the distance data so as to suppress a change in the luminance of the reflected light caused by the length (shape of measurement target) of the distance during the scanning of the three-dimensional scanner 101.

According to the above configuration, it is possible to suppress a change in luminance of the reflected light caused by the length of the distance during the scanning of the three-dimensional scanner 101.

### First Example Embodiment

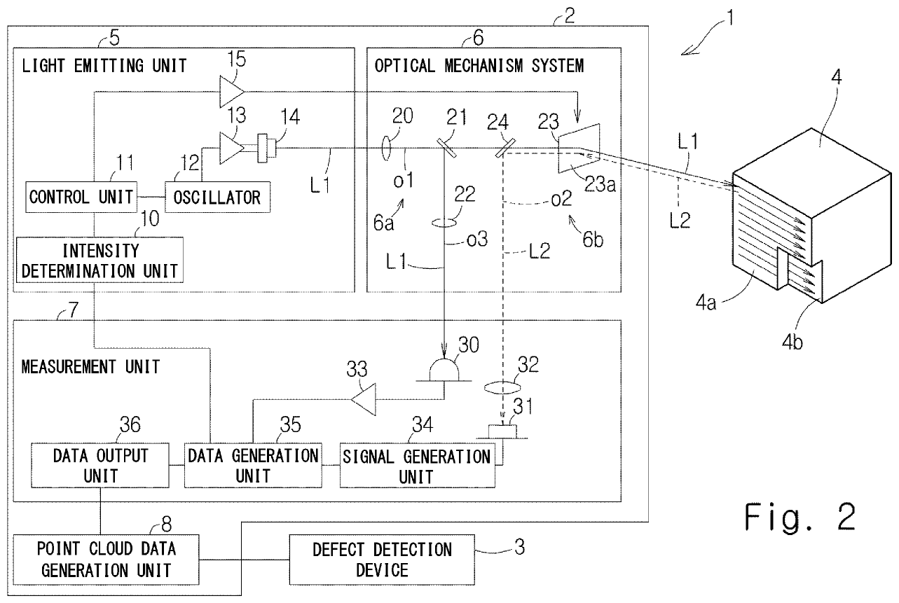

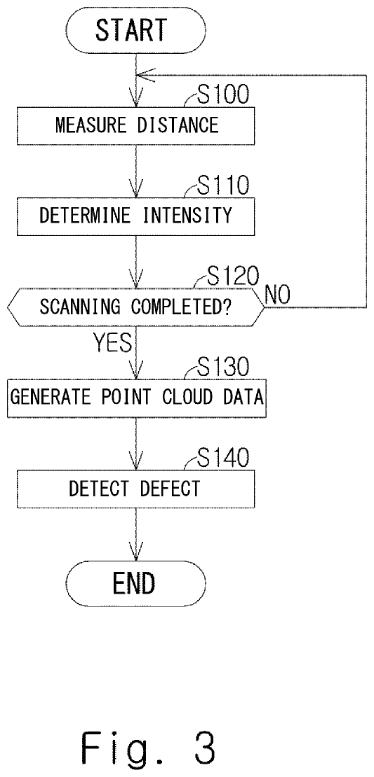

Next, a first example embodiment of the present disclosure will be described with reference to FIGS. 2 and 3.

FIG. 2 is a functional block diagram of an optical sensing system 1. As illustrated in FIG. 2, the optical sensing system 1 includes a three-dimensional Lidar scanner 2 and a defect detection device 3.

The three-dimensional Lidar scanner 2 generates point cloud data of a building 4 which is a specific example of a measurement target. The defect detection device 3 detects a defect such as a crack that may occur on the surface of the building 4 based on the point cloud data generated by the three-dimensional Lidar scanner 2. In the present example embodiment, the measurement target is assumed to be a stationary object. The stationary object includes, for example, an object having no movable portion such as a building and an object having a movable portion such as a movable bridge and being in a stationary state.

The three-dimensional Lidar scanner 2 includes a light emitting unit 5, an optical mechanism system 6, a measurement unit 7, and a point cloud data generation unit 8.

The light emitting unit 5 includes an intensity determination unit 10, a control unit 11, an oscillator 12, a light source driver 13, a light source 14, and a scan driver 15.

The optical mechanism system 6 includes an irradiation optical system 6a and a light receiving optical system 6b. The irradiation optical system 6a includes a lens 20, a first optical element 21, a lens 22, and a mirror 23. The light receiving optical system 6b includes a second optical element 24 and a mirror 23. That is, the irradiation optical system 6a and the light receiving optical system 6b share the mirror 23.

The measurement unit 7 includes a photodetector 30, a sensor 31, a lens 32, an amplifier 33, a signal generation unit 34, a data generation unit 35, and a data output unit 36.

The intensity determination unit 10 determines the intensity of laser light L1 emitted from the light source 14, and outputs an intensity signal indicating the determined intensity to the control unit 11.

The control unit 11 controls the oscillator 12 based on the intensity signal input from the intensity determination unit 10. The light source driver 13 drives the light source 14 based on the pulse signal generated by the oscillator 12. The light source 14 is, for example, a laser light source such as a laser diode. The light source 14 is driven by the light source driver 13 to intermittently emit a laser light L1.

The light source 14, the lens 20, the first optical element 21, the second optical element 24, and the mirror 23 are arranged in this order on the optical axis O1 of the irradiation optical system 6a. The optical axis O1 can be defined as a focal axis of the lens 20 passing through the center position of the lens 20.

The lens 20 collimates the laser light L1 intermittently emitted from the light source 14 and guides the laser light L1 to the first optical element 21.

The first optical element 21 is typically a light splitter. The laser light L1 passes through the first optical element 21, is reflected by the first optical element 21, travels along the optical axis O3, and enters the photodetector 30.

The second optical element 24 is typically a half mirror. The laser light L1 passes through the second optical element 24 and enters the mirror 23.

The mirror 23 has a reflecting surface 23a that reflects the laser light L1 intermittently emitted from the light source 14. For example, the reflecting surface 23a is rotatable about two rotation axes crossing each other. Thus, the mirror 23 periodically changes the irradiation direction of the laser light L1. The mirror 23 is typically a polygon mirror driven by a motor. However, instead of this, MEMS may be adopted.

The control unit 11 outputs a drive signal to the scan driver 15 so that the inclination accuracy of the reflecting surface 23a of the mirror 23 periodically changes. The scan driver 15 drives the mirror 23 based on a drive signal input from the control unit 11. That is, the control unit 11 controls the irradiation direction of the laser light L1 by driving the scan driver 15.

FIG. 2 illustrates a raster scan method as a scanning method. However, instead of this, a conical scan method may be adopted.

The reflecting surface 23a of the mirror 23, the second optical element 24, the lens 32, and the sensor 31 are arranged on the optical axis O2 of the light receiving optical system 6b in order of incidence of the reflected light L2. The optical axis O2 can be defined as a focal axis of the lens 32 passing through the center position of the lens 32.

The reflecting surface 23a allows the reflected light L2 traveling along the optical axis O2 among the scattered light scattered by the building 4 to enter the second optical element 24. The second optical element 24 reflects the reflected light L2 reflected by the reflecting surface 23a to be incident on the lens 32 of the measurement unit 7 along the optical axis O2. The lens 32 condenses the reflected light L2 incident along the optical axis O2 on the sensor 31.

In FIG. 2, the optical path of the laser light L1 and the optical path of the reflected light L2 are separated from each other for clarity. In practice, however, they may overlap. In addition, an optical path at the center of the light flux of the laser light L1 is illustrated as the optical axis O1. Similarly, the optical path at the center of the light flux of the reflected light L2 is illustrated as the optical axis O2.

The sensor 31 is typically a photomultiplier. The sensor 31 converts the luminance of the reflected light L2 received via the light receiving optical system 6b into an electrical signal.

The measurement unit 7 measures the distance from the three-dimensional Lidar scanner 2 to the building 4 based on a time-series luminance signal obtained by analog-digital conversion of an electrical signal obtained by converting the reflected light L2 into a signal. Specifically, it is as follows.

The signal generation unit 34 converts the electrical signal output from the sensor 31 into a time-series luminance signal at a predetermined sampling interval. The time-series luminance signal is a sequence of luminance values obtained by sampling a temporal change in luminance of the reflected light L2 at a predetermined sampling interval.

The data generation unit 35 measures the distance from the three-dimensional Lidar scanner 2 to the building 4 based on the time difference between the timing at which the photodetector 30 detects the laser light L1 and the timing at which the sensor 31 detects the reflected light L2 based on the time-series luminance signal, and generates distance data. In addition, the data generation unit 35 generates luminance data indicating the luminance of the reflected light L2 detected by the sensor 31 based on the time-series luminance signal. The data generation unit 35 outputs the distance data to the intensity determination unit 10, and outputs the distance data and the luminance data to the data output unit 36.

The data output unit 36 outputs the distance data and the luminance data to the point cloud data generation unit 8.

The point cloud data generation unit 8 generates point cloud data based on the distance data and the luminance data input from the data output unit 36. The point cloud data is typically a set of point data having coordinate data and luminance data.

Next, the intensity determination unit 10 will be described in detail. The intensity determination unit 10 dynamically determines the intensity of the laser light L1 so as to suppress a change in the luminance of the reflected light L2 due to the length of the distance from the three-dimensional Lidar scanner 2 to the building 4 during the scanning of the three-dimensional Lidar scanner 2. The intensity determination unit 10 dynamically determines the intensity of the laser light L1 based on the distance data input from the data generation unit 35 so as to suppress the above-described change. That is, the intensity determination unit 10 determines the intensity of the laser light L1 such that the distance from the three-dimensional Lidar scanner 2 to the building 4 and the intensity of the laser light L1 have a positive correlation. In other words, the intensity determination unit 10 relatively increases the intensity of the laser light L1 when the distance from the three-dimensional Lidar scanner 2 to the building 4 is relatively long, and relatively decreases the intensity of the laser light L1 when the distance from the three-dimensional Lidar scanner 2 to the building 4 is relatively short.

In the present example embodiment, the intensity determination unit 10 dynamically determines the intensity of the laser light L1 based on a value obtained by squaring the distance from the three-dimensional Lidar scanner 2 to the building 4. Specifically, the intensity determination unit 10 dynamically determines the intensity of the laser light L1 according to Equation (1) below. As described above, the three-dimensional Lidar scanner 2 repeatedly measures the distance from the three-dimensional Lidar scanner 2 to the building 4 by repeatedly scanning the building with the laser light L1 and receiving the reflected light L2. In Equation (1), P n is the intensity of the laser light L1 emitted from the light source 14 for the n-th measurement. P₀ and A are constants. rₙ₋₁ is distance data obtained by the (n−1)th measurement.

[Mathematical Formula 1]

Pₙ=P₀+Arₙ₋₁² (1)

According to Equation (1), it is possible to prevent a decrease in the luminance of the reflected light L2 due to an increase in the distance from the three-dimensional Lidar scanner 2 to the building 4 during the scanning of the three-dimensional Lidar scanner 2. In other words, it is possible to prevent the variation in the luminance of the reflected light L2 due to the variation in the distance from the three-dimensional Lidar scanner 2 to the building 4 during the scanning of the three-dimensional Lidar scanner 2.

That is, for example, as illustrated in FIG. 2, it is assumed that the measurement target surface of the building 4 is partially recessed, so that the building 4 has a surface 4a relatively close to the three-dimensional Lidar scanner 2 and a surface 4b relatively far from the three-dimensional Lidar scanner 2. In addition, it is assumed that the intensity of the laser light L1 emitted from the three-dimensional Lidar scanner 2 when measuring the distance from the three-dimensional Lidar scanner 2 to the surface 4a is equal to the intensity of the laser light L1 emitted from the three-dimensional Lidar scanner 2 when measuring the distance from the three-dimensional Lidar scanner 2 to the surface 4b. In this case, the luminance of the reflected light L2 received from the surface 4b by the three-dimensional Lidar scanner 2 is lower than the luminance of the reflected light L2 received from the surface 4a by the three-dimensional Lidar scanner 2. In general, the luminance of the reflected light L2 is inversely proportional to the square of the distance from the three-dimensional Lidar scanner 2 to the measurement target. Therefore, according to Equation (1), it is possible to prevent a decrease in the luminance of the reflected light L2 due to an increase in the distance from the three-dimensional Lidar scanner 2 to the building 4 while the three-dimensional Lidar scanner 2 is scanning the building 4.

Next, the operation of the three-dimensional Lidar scanner 2 will be described with reference to FIG. 3. FIG. 3 illustrates an operation flow of the three-dimensional Lidar scanner 2.

As illustrated in FIG. 3, the control unit 11 executes (n−1)th distance measurement (S100). Next, the intensity determination unit 10 substitutes the distance data obtained by the (n−1)th measurement into Equation (1) to determine the intensity of the laser light L1 in the n-th distance measurement (S110). Next, the control unit 11 determines whether scanning in a predetermined scanning range has been completed. When determining that the scanning is completed (S120: YES), the control unit 11 advances the processing to S130. On the other hand, when it is determined that the scanning is not completed (S120: NO), the control unit 11 returns the processing to S100 and executes n-th distance measurement. In S130, the point cloud data generation unit 8 generates the point cloud data based on the data output from the data output unit 36 (S130). Then, the defect detection device 3 detects a defect of the building 4 based on the point cloud data generated by the point cloud data generation unit 8 (S140). The defect of the building 4 is typically a crack that may occur on the surface of the building 4. In the luminance data of each point in the point cloud data generated by the point cloud data generation unit 8 of the present example embodiment, noise caused by the length of the measured distance is removed in advance. Therefore, the defect detection device 3 can detect the defect of the building 4 with high accuracy based on the point cloud data generated by the point cloud data generation unit 8.

The first example embodiment has been described above, and the first example embodiment has the following features.

The optical sensing system 1 includes the three-dimensional Lidar scanner 2 (three-dimensional scanner) and the intensity determination unit 10 (intensity determination means). The three-dimensional Lidar scanner 2 scans the building 4 (measurement target) with the laser light L1 and receives the reflected light L2, thereby generating distance data indicating the distance to the building 4 and luminance data indicating the luminance of the reflected light L2. The intensity determination unit 10 dynamically determines the intensity of the laser light L1 based on the distance data so as to suppress a change in the luminance of the reflected light L2 due to the length of the distance from the three-dimensional Lidar scanner 2 to the building 4 during the scanning of the three-dimensional Lidar scanner 2. In other words, the intensity determination unit 10 dynamically determines the intensity of the laser light L1 based on the distance data so as to suppress a change in the luminance of the reflected light L2 due to the length of the distance from the three-dimensional Lidar scanner 2 to the distance measurement point on the building 4 during the scanning of the three-dimensional Lidar scanner 2. The distance measurement point on the building 4 is a portion irradiated with the laser light L1 in the building 4. The distance measurement point on the building 4 is typically a portion irradiated with the laser light L1 on the wall surface of the building 4. For example, when there is a local recess on the wall surface of the building 4, the intensity determination unit 10 dynamically determines the intensity of the laser light L1 such that the intensity of the laser light L1 emitted to the inside of the recess is higher than the intensity of the laser light L1 emitted to the outside of the recess. Dynamically determining the intensity of the laser light L1 means determining the intensity of the laser light L1 in real time during the scanning of the three-dimensional Lidar scanner 2. According to the above configuration, it is possible to suppress the change in the luminance of the reflected light L2 due to the length of the distance from the three-dimensional Lidar scanner 2 to the building 4 during the scanning of the three-dimensional Lidar scanner 2.

In addition, the intensity determination unit 10 determines the intensity of the laser light L1 such that the distance from the three-dimensional Lidar scanner 2 to the building 4 and the intensity of the laser light L1 have a positive correlation. According to the above configuration, it is possible to effectively suppress the change in the luminance of the reflected light L2 caused by the length of the distance from the three-dimensional Lidar scanner 2 to the building 4 during the scanning of the three-dimensional Lidar scanner 2.

In addition, the intensity determination unit 10 determines the intensity based on a value obtained by squaring the distance from the three-dimensional Lidar scanner 2 to the building 4. According to the above configuration, it is possible to more effectively suppress the change in the luminance of the reflected light L2 caused by the length of the distance from the three-dimensional Lidar scanner 2 to the building 4 during the scanning of the three-dimensional Lidar scanner 2.

When the distance from the three-dimensional Lidar scanner 2 to the building 4 changes stepwise during the scanning of the three-dimensional Lidar scanner 2, the luminance of the reflected light L2 immediately after the change in stepwise may inevitably decrease. Therefore, for example, when the difference between the n-th distance data and the (n+1)th distance data exceeds a predetermined value, the (n+1)th distance data and the luminance data may be discarded.

In the first example embodiment, the three-dimensional Lidar scanner 2 includes the intensity determination unit 10 and the point cloud data generation unit 8. That is, the three-dimensional Lidar scanner 2, the intensity determination unit 10, and the point cloud data generation unit 8 are realized by a single device. However, the three-dimensional Lidar scanner 2, the intensity determination unit 10, and the point cloud data generation unit 8 may be realized by distributed processing by a plurality of devices. For example, a computer capable of performing bidirectional communication with the three-dimensional Lidar scanner 2 may function as the intensity determination unit 10 and the point cloud data generation unit 8, and this computer may be a cloud computer.

### Modified Example

Next, a modified example of the first example embodiment will be described.

In the first example embodiment, the intensity determination unit 10 dynamically determines the intensity of the laser light L1 based on the value obtained by squaring the distance from the three-dimensional Lidar scanner 2 to the building 4.

Alternatively, the intensity determination unit 10 may dynamically determine the intensity of the laser light L1 based on a comparison result obtained by comparing the distance from the three-dimensional Lidar scanner 2 to the building 4 with a predetermined value. Specifically, the intensity determination unit 10 sets the intensity of the laser light L1 to the first intensity when the distance from the three-dimensional Lidar scanner 2 to the building 4 is longer than a predetermined value, and sets the intensity of the laser light L1 to the second intensity lower than the first intensity when the distance is shorter than the predetermined value. According to the above configuration, it is possible to suppress the change in the luminance of the reflected light L2 due to the length of the distance from the three-dimensional Lidar scanner 2 to the building 4 during the scanning of the three-dimensional Lidar scanner 2 with extremely simple calculation.

### Second Example Embodiment

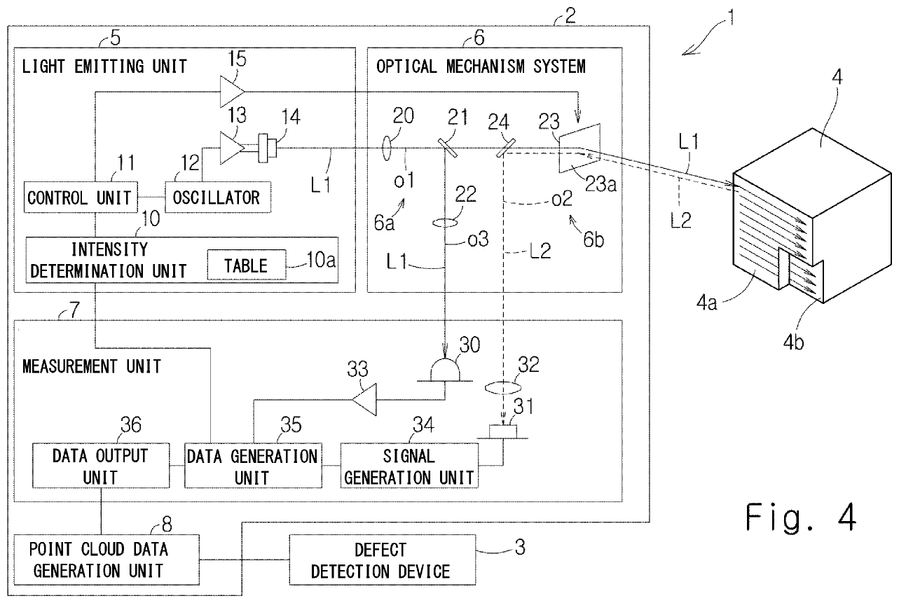

Next, a second example embodiment will be described with reference to FIG. 4. FIG. 4 is a functional block diagram of the optical sensing system 1.

As illustrated in FIG. 4, in the present example embodiment, the intensity determination unit 10 includes an intensity determination table 10a. The intensity determination table 10a is a table indicating a correspondence relationship between distance and intensity. In the intensity determination table 10a, the distance and the intensity have a positive correlation. The intensity determination unit 10 dynamically determines the intensity of laser light L1 by referring to the intensity determination table 10a. According to the above configuration, it is possible to suppress the change in the luminance of the reflected light L2 due to the length of the distance from the three-dimensional Lidar scanner 2 to the building 4 during the scanning of the three-dimensional Lidar scanner 2 without requiring special calculation.

The first example embodiment and the second example embodiment of the present disclosure have been described above.

The present disclosure is not limited to the foregoing example embodiments, and can be appropriately changed without departing from the gist.

For example, in each of the above example embodiments, the distance measurement method of the three-dimensional Lidar scanner 2 is a direct time of flight (dToF) method. However, instead of this, a frequency modulated continuous wave (FMCW) method may be adopted.

In each of the above example embodiments, one building, that is, the building 4 has been exemplified as an object to be measured by the three-dimensional Lidar scanner 2. However, the object to be measured by the three-dimensional Lidar scanner 2 may include a plurality of buildings. Examples of the plurality of buildings include a plurality of steel towers having different distances from the three-dimensional Lidar scanner 2 and a plurality of bridge piers (piers: so-called bridge lower structures) having different distances from the three-dimensional Lidar scanner 2. As described above, even in a case where the object to be measured by the three-dimensional Lidar scanner 2 includes a plurality of buildings, it is possible to suppress the difference in the luminance of the reflected light due to the length of the distance to each building during scanning.

Furthermore, for example, the intensity determination unit 10 may use a learned model learned to suppress a change in the luminance of the reflected light L2 due to the length of the distance from the three-dimensional Lidar scanner 2 to the building 4 during the scanning of the three-dimensional Lidar scanner 2. The intensity determination unit 10 dynamically determines the intensity of the laser light L1 using the learned model. The learned model is typically a neural network that outputs the intensity of the laser light L1 when a distance is input.

The intensity determination unit 10 and point cloud data generation unit 8 may be realized in a hardware circuit, such as FPGA (Field Programmable Gate Array), ASIC (Application-Specific Integrated Circuit), Microcontroller, Microprocessor, Digital Signal Processor (DSP), GPU (Graphics Processing Unit).

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The whole or part of the exemplary embodiments disclosed above can be described as, but not limited to, the following supplementary notes.

(Supplementary Note 1)

An optical sensing system including:
a three-dimensional scanner configured to scan a measurement target with a laser light and receive reflected light of the laser light to generate distance data indicating a distance to the measurement target and luminance data indicating luminance of the reflected light; and
an intensity determination means for dynamically determining intensity of the laser light based on the distance data so as to suppress a change in luminance of the reflected light caused by a length of the distance during the scanning of the three-dimensional scanner.

(Supplementary Note 2)

The optical sensing system according to Supplementary note 1, wherein the intensity determination means determines the intensity of the laser light so that the distance and the intensity have a positive correlation.

(Supplementary Note 3)

The optical sensing system according to Supplementary note 2, wherein the intensity determination means determines the intensity of the laser light based on a value obtained by squaring the distance.

(Supplementary Note 4)

The optical sensing system according to Supplementary note 2, wherein the intensity determination means is configured to:
determine the intensity of the laser light as a first intensity when the distance is longer than a predetermined value, and determine the intensity of the laser light as a second intensity lower than the first intensity when the distance is shorter than the predetermined value.

(Supplementary Note 5)

The optical sensing system according to Supplementary note 2, wherein the intensity determination means determines the intensity by referring to an intensity determination table indicating a correspondence relationship between the distance and the intensity of the laser light.

(Supplementary Note 6)

The optical sensing system according to any one of Supplementary notes 1 to 5, further including a point cloud data generation means for generating point cloud data based on the distance data and the luminance data generated by the three-dimensional scanner.

(Supplementary Note 7)

An optical sensing device including:
a three-dimensional scanner configured to scan a measurement target with a laser light and receive reflected light of the laser light to generate distance data indicating a distance to the measurement target and luminance data indicating luminance of the reflected light; and
an intensity determination means for dynamically determining intensity of the laser light based on the distance data so as to suppress a change in luminance of the reflected light caused by a length of the distance during the scanning of the three-dimensional scanner.

(Supplementary Note 8)

The optical sensing device according to Supplementary note 7, wherein the intensity determination means determines the intensity of the laser light so that the distance and the intensity have a positive correlation.

(Supplementary Note 9)

The optical sensing device according to Supplementary note 8, wherein the intensity determination means determines the intensity of the laser light based on a value obtained by squaring the distance.

(Supplementary Note 10)

The optical sensing device according to Supplementary note 8, wherein the intensity determination means is configured to:
determine the intensity of the laser light as a first intensity when the distance is longer than a predetermined value, and
determine the intensity of the laser light as a second intensity lower than the first intensity when the distance is shorter than the predetermined value.

(Supplementary Note 11)

The optical sensing device according to Supplementary note 8, wherein the intensity determination means determines the intensity by referring to an intensity determination table indicating a correspondence relationship between the distance and the intensity of the laser light.

(Supplementary Note 12)

The optical sensing device according to any one of Supplementary notes 7 to 11, further including a point cloud data generation means for generating point cloud data based on the distance data and the luminance data generated by the three-dimensional scanner.

(Supplementary Note 13)

An optical sensing method including:
a distance measurement step of scanning a measurement target with a laser light and receiving reflected light of the laser light to generate distance data indicating a distance to the measurement target and luminance data indicating luminance of the reflected light; and
an intensity determination step of dynamically determining intensity of the laser light based on the distance data so as to suppress a change in luminance of the reflected light caused by a length of the distance during the scanning.

(Supplementary Note 14)

The optical sensing method according to Supplementary note 13, wherein the intensity determination step involves determining the intensity of the laser light so that the distance and the intensity have a positive correlation.

(Supplementary Note 15)

The optical sensing method according to Supplementary note 14, wherein the intensity determination step involves determining the intensity based on a value obtained by squaring the distance.

(Supplementary Note 16)

The optical sensing method according to Supplementary note 14, wherein the intensity determination step involves:
determining the intensity of the laser light as a first intensity when the distance is longer than a predetermined value, and
determining the intensity of the laser light as a second intensity lower than the first intensity when the distance is shorter than the predetermined value.

(Supplementary Note 17)

The optical sensing method according to Supplementary note 14, wherein the intensity determination step involves determining the intensity by referring to an intensity determination table indicating a correspondence relationship between the distance and the intensity of the laser light.

(Supplementary Note 18)

The optical sensing method according to any one of Supplementary notes 13 to 17, further including a point cloud data generation step of generating point cloud data based on the distance data and the luminance data generated in the distance measurement step.

(Supplementary Note 19)

A program for causing a computer to execute:
a distance measurement step of scanning a measurement target with a laser light and receiving reflected light of the laser light to generate distance data indicating a distance to the measurement target and luminance data indicating luminance of the reflected light; and
an intensity determination step of dynamically determining intensity of the laser light based on the distance data so as to suppress a change in luminance of the reflected light caused by a length of the distance during the scanning.

(Supplementary Note 20)

The program according to Supplementary note 19, wherein the intensity determination step involves determining the intensity of the laser light so that the distance and the intensity have a positive correlation.

(Supplementary Note 21)

The program according to Supplementary note 20, wherein the intensity determination step involves determining the intensity based on a value obtained by squaring the distance.

(Supplementary Note 22)

The program according to Supplementary note 20, wherein the intensity determination step involves:
determining the intensity of the laser light as a first intensity when the distance is longer than a predetermined value, and
determining the intensity of the laser light as a second intensity lower than the first intensity when the distance is shorter than the predetermined value.

(Supplementary Note 23)

The program according to Supplementary note 20, wherein the intensity determination step involves determining the intensity by referring to an intensity determination table indicating a correspondence relationship between the distance and the intensity of the laser light.

(Supplementary Note 24)

The program according to any one of Supplementary notes 19 to 23, further causing the computer to execute:
a point cloud data generation step of generating point cloud data based on the distance data and the luminance data generated in the distance measurement step.

An example advantage according to the above-described embodiments is that it is possible to suppress a change in luminance of the reflected light due to the length of the distance during scanning.

The first and second embodiments can be combined as desirable by one of ordinary skill in the art.

While the disclosure has been particularly shown and described with reference to embodiments thereof, the disclosure is not limited to these embodiments. It will be understood by those of ordinary skill in the art that various changes in form and details may be made therein without departing from the spirit and scope of the present disclosure as defined by the claims.

What is claimed is:

1. An optical sensing system comprising:
a three-dimensional scanner configured to scan a measurement target with a laser light and receive reflected light of the laser light to generate distance data indicating a distance to the measurement target and luminance data indicating luminance of the reflected light, and
an intensity determination circuit configured to dynamically determine intensity of the laser light based on the distance data so as to suppress a change in luminance of the reflected light caused by a length of the distance during the scanning of the three-dimensional scanner.

2. The optical sensing system according to claim 1, wherein the intensity determination circuit is further configured to determine the intensity of the laser light so that the distance and the intensity have a positive correlation.

3. The optical sensing system according to claim 2, wherein the intensity determination circuit is further configured to determine the intensity of the laser light based on a value obtained by squaring the distance.

4. The optical sensing system according to claim 2, wherein the intensity determination circuit is further configured to:
determine the intensity of the laser light as a first intensity when the distance is longer than a predetermined value, and
determine the intensity of the laser light as a second intensity lower than the first intensity when the distance is shorter than the predetermined value.

5. The optical sensing system according to claim 2, wherein the intensity determination circuit is further configured to determine the intensity by referring to an intensity determination table indicating a correspondence relationship between the distance and the intensity of the laser light.

6. The optical sensing system according to claim 1, further comprising a point cloud data generation circuit configured to generate point cloud data based on the distance data and the luminance data generated by the three-dimensional scanner.

7. An optical sensing device comprising:
a three-dimensional scanner configured to scan a measurement target with a laser light and receive reflected light of the laser light to generate distance data indicating a distance to the measurement target and luminance data indicating luminance of the reflected light, and
an intensity determination circuit configured to dynamically determine intensity of the laser light based on the distance data so as to suppress a change in luminance of the reflected light caused by a length of the distance during the scanning of the three-dimensional scanner.

8. The optical sensing device according to claim 7, wherein the intensity determination circuit is further configured to determine the intensity of the laser light so that the distance and the intensity have a positive correlation.

9. The optical sensing device according to claim 8, wherein the intensity determination circuit is further configured to determine the intensity of the laser light based on a value obtained by squaring the distance.

10. The optical sensing device according to claim 8, wherein the intensity determination circuit is further configured to:
determine the intensity of the laser light as a first intensity when the distance is longer than a predetermined value, and
determine the intensity of the laser light as a second intensity lower than the first intensity when the distance is shorter than the predetermined value.

11. The optical sensing device according to claim 8, wherein the intensity determination circuit is further configured to determine the intensity by referring to an intensity determination table indicating a correspondence relationship between the distance and the intensity of the laser light.

12. The optical sensing device according to claim 7, further comprising a point cloud data generation circuit configured to generate point cloud data based on the distance data and the luminance data generated by the three-dimensional scanner.

13. An optical sensing method comprising:
scanning a measurement target with a laser light and receiving reflected light of the laser light to generate distance data indicating a distance to the measurement target and luminance data indicating luminance of the reflected light; and
dynamically determining intensity of the laser light based on the distance data so as to suppress a change in luminance of the reflected light caused by a length of the distance during the scanning.

14. The optical sensing method according to claim 13, wherein the dynamically determining involves determining the intensity of the laser light so that the distance and the intensity have a positive correlation.

15. The optical sensing method according to claim 14, wherein the dynamically determining involves determining the intensity of the laser light based on a value obtained by squaring the distance.

16. The optical sensing method according to claim 14, wherein the dynamically determining involves:
determining the intensity of the laser light as a first intensity when the distance is longer than a predetermined value, and
determining the intensity of the laser light as a second intensity lower than the first intensity when the distance is shorter than the predetermined value.

17. The optical sensing method according to claim 14, wherein the dynamically determining involves determining the intensity by referring to an intensity determination table indicating a correspondence relationship between the distance and the intensity of the laser light.

18. The optical sensing method according to claim 13, further comprising generating point cloud data based on the distance data and the luminance data generated in the scanning.
